(19) United States
(12) Patent Application Publication
(10) Pub. No.: US 2019/0151860 A1
(43) Pub. Date: May 23, 2019

(54) FLOTATION AGENT OF THIOL ETHER STRUCTURE

(71) Applicant: Arkema France, Colombes (FR)

(72) Inventor: Bernard MONGUILLON, Nogent Sur Marne (FR)

(21) Appl. No.: 15/759,549

(22) PCT Filed: Sep. 16, 2016
(86) PCT No.: PCT/FR2016/052355

§ 371 Date: Mar. 13, 2018

(30) Foreign Application Priority Data
Sep. 17, 2015 (FR) 1558755

(51) Int. Cl. B03D 1/012; B03D 1/008; B03D 1/01

(52) U.S. Cl. CPC B03D 1/012; B03D 1/008; B03D 2201/02; B03D 2203/02; B03D 2203/025; B03D 1/01

(57) ABSTRACT

The invention relates to a flotation agent of formula (I):

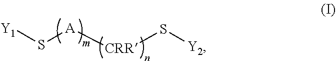

where A is chosen from: (II), (III), or (IV):

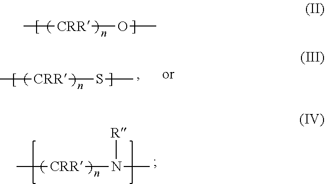

in which: the group R represents a hydrogen atom or a linear or branched, saturated or unsaturated, C₁-C₄ alkyl radical; the group R′, which is identical or different from the group R, represents a hydrogen atom or a linear or branched, saturated or unsaturated, C₁-C₄ alkyl radical; the group R″, which is identical or different from the groups R and R′, represents a hydrogen atom or a linear or branched, saturated or unsaturated, C₁-C₄ alkyl radical; n is an integer between 1 and 6; m is an integer between 1 and 20; Y₁ and Y₂, are chosen independently from X₁ or a radical C(S)SX₂, wherein X₁ is a hydrogen atom, an alkali metal or an alkaline-earth metal, and X₂ is an alkali metal or an alkaline-earth metal.

The invention relates to the general field of the recovery of metals, and more especially the flotation of ores, in particular oxide-based and sulfide-based ores. It relates more particularly to a particular flotation agent.

Flotation, which at the current time has reached an advanced degree of development, is a well-known process of which the objective is to enrich ores starting from low-content ores by means of a concentration step. This step comes before a subsequent treatment comprising heat treatment (also called smelting) or leaching and refining.

The enrichment of ores by flotation, using an agent which brings about selective flotation of ores, constitutes a conventional operation.

The ores generally involved are oxide and/or sulfide ores of lead, zinc, copper, silver, gold, molybdenum and metals belonging to the platinum group: platinum, palladium, rhodium, ruthenium, iridium and osmium.

The art of froth flotation for separating and concentrating the desired metal from the unwanted ores and from the gangue is a well-known process.

The ores are dispersed in a gangue consisting of various impurities, in particular siliceous impurities. The ores are, after extraction from the mine, crushed, and then ground in a wet medium in order to give particles of sufficient fineness to release the crystals of the desired compounds.

In general, direct flotation comprises the formation of an aqueous suspension of the finely ground ore at an approximate solids content of 30%, the addition to this suspension of a foaming agent and of a collector, and the stirring of the mixture until it is surmounted by a foam. The collector is absorbed onto the surface of the ores and creates hydrophobic characteristics that enable the ore that it is desired to recover to attach to the foam bubbles and to be removed from the unwanted gangue. This foaming operation can be repeated for the purpose of increasing the amount of metal collected and of forming flotation concentrates with a high metal content.

The flotation concentrate then has a desired metal content, which is thus considerably higher than that of the original ore. This content depends on the initial content of the ore and especially on the selectivity of the flotation process.

It is therefore very advantageous to obtain, at the end of the flotation step, a concentrate which has the highest possible metal content.

There is therefore an advantage in making the flotation process as efficient as possible in order to obtain better separation of the desired ores and to obtain said ores with improved yields and improved selectivity.

This is in particular reflected by the search for the strongest possible selective action of the flotation agents.

Flotation agents (or else “collectors”), commonly used at the present time, are in particular xanthates, dithiophosphates, dithiocarbamates, mercaptobenzothiazoles and mercaptans, or even amines, fatty amines, alkoxylated amines, and the like, and mixtures thereof.

The use of mercaptans as flotation agents is in fact known. French patent application FR 2 371 967 thus discloses the use, for obtaining flotation concentrates, of a solution of mercaptan, which may be an alkyl mercaptan corresponding to the formula CₙH₂ₙ₊₁SH, the value of n varying from 12 to 16, and more particularly n-dodecyl mercaptan, in a polyglycol in order to isolate copper.

Patent FR 2 534 492 relates to a flotation composition comprising a collector, for example a sulfur-comprising organic compound, such as a mercaptan, in particular in combination with a surfactant compound and a co-surfactant. Said patent also relates to an ore flotation process which consists in introducing said composition in the form of a microemulsion into the ore pulp to be treated.

Patent EP 0 193 630 describes, for its part, a composition comprising a mixture of alkyl trithiocarbamates and alkyl mercaptans, or salts thereof, intended to be used as flotation agent.

Patent FR 1 544 443 discloses the use, as flotation agent, of a dithiol compound of formula HSRSH, in which R is an organic radical comprising from 6 to 18 carbon atoms. Said organic radical comprises an alkyl or aromatic chain. The dithiol compound can be an aliphatic, alicyclic, aralkyl, alkaryl or aryl compound.

Nevertheless, mercaptans are characterized by a strong odor. Thus, an unpleasant sensation is associated with the handling thereof.

Moreover, the improving of the efficiency of ore flotation processes is an ongoing objective that those working in the field have set themselves. The same is true of the search for better selectivity of the flotation agents and for improved yields regarding the obtaining of ores.

It would therefore be advantageous to provide a flotation agent which makes it possible to overcome the abovementioned drawbacks.

A subject of the present invention is therefore a flotation agent of formula (I):

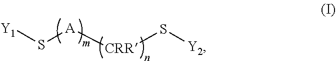

A corresponding to a formula chosen from:

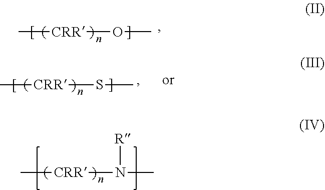

in which:
the group R represents a hydrogen atom or a linear or branched, saturated or unsaturated C₁-C₄ alkyl radical;
the group R′, which may be identical to or different than the group R, represents a hydrogen atom or a linear or branched, saturated or unsaturated C₁-C₄ alkyl radical;
the group R″, which may be identical to or different than the groups R and R′, represents a hydrogen atom or a linear or branched, saturated or unsaturated C₁-C₄ alkyl radical;
n is an integer ranging from 1 to 6;
m is an integer ranging from 1 to 20;
the groups Y₁ and Y₂, independently of one another, are chosen from X₁ and a radical C(S)SX₂, X₁ being chosen from a hydrogen atom and an alkali metal, preferably chosen from sodium and potassium, and X₂ being chosen from a hydrogen atom and an alkali metal, preferably chosen from sodium and potassium.

Preferably, X₂ represents an alkali metal, preferably sodium or potassium.

Other advantages and characteristics of the invention will become more clearly apparent on examining the detailed description.

The compounds of formula (I) are known and commercially available or else are easily prepared using known procedures that are available in the patent literature, in the scientific literature, on the Internet and in Chemical Abstracts. Mention may be made, by way of example and in a nonlimiting manner, of patent JP2008214577, which describes the preparation of trithiocarbonate by reaction of dichlorodioxaoctane with Na₂CS₃, followed by an acidification step. More generally, the above compound is obtained by reacting a dihalogenated compound in the presence either of thiourea or of ammonium hydrosulfide or sodium hydrosulfide, followed by a purification step. The various operating conditions for preparing the thiol are available in the patent literature, in the scientific literature, on the Internet and in Chemical Abstracts.

The dimercaptan obtained is then reacted in the presence of a base and of carbon disulfide according to the operating conditions known to those skilled in the art.

Furthermore, it is specified that the expression “from . . . to . . . ” used in the present description should be understood as including each of the limits mentioned.

The flotation agent according to the invention is of formula (I) mentioned above, A corresponding to a formula chosen from formulae (II), (III) and (IV) mentioned above, preferably (II) and (IV), and more preferably A corresponds to formula (II).

Advantageously, the group R represents a hydrogen atom or a C₁-C₂ alkyl radical, preferably a hydrogen atom.

Preferentially, the group R′ represents a hydrogen atom or a C₁-C₂ alkyl radical, preferably a hydrogen atom.

Preferably, the group R″ represents a hydrogen atom or a C₁-C₂ alkyl radical, preferably a hydrogen atom.

According to one particular embodiment, n is an integer ranging from 1 to 4, preferably ranging from 1 to 3.

Particularly preferably, when the groups R and R′ represent a hydrogen atom and when n is an integer ranging from 1 to 4, this means that the group (CRR′)ₙ represents a methyl, ethyl, propyl or butyl group.

Advantageously, m is an integer ranging from 2 to 5.

Preferentially, the groups R, R′ and R″, which may be identical or different, represent a group chosen from a hydrogen atom, a methyl group, an ethyl group, a propyl group, a butyl group and isomers thereof.

According to one preferred embodiment, A corresponds to a formula chosen from formulae (II) and (IV).

According to one preferred embodiment, A corresponds to a formula chosen from formulae (II) and (III).

According to one particularly preferred embodiment, A corresponds to formula (II).

Particularly preferably, when the groups R and R′ represent a hydrogen atom and when m is an integer ranging from 2 to 5, the group A represents an ethoxy, propoxy, methyl(ethoxy), butoxy, (dimethyl)ethoxy, (methyl)propoxy or (ethyl)ethoxy group.

Advantageously, X₁ represents a hydrogen atom or an alkali metal, preferably chosen from sodium and potassium.

Particularly advantageously, X₁ is a hydrogen atom.

Preferentially, X₂ is an alkali metal, preferably chosen from sodium and potassium.

Preferably, the groups Y₁ and Y₂ each represent a hydrogen atom.

According to another embodiment, the groups Y₁ and Y₂, which may be identical or different, each represent a radical C(S)SX₂ where X₂ is as defined above.

In addition, the agent according to the invention contains heteroatoms. These heteroatoms surprisingly provide the agent according to the invention with a considerable chelating effect, which makes it possible to increase the yield and to improve the stability of the metal derivatives thus formed during the ore extraction by the flotation process, preferably froth flotation process. Moreover, the heteroatoms can also provide a greater wetting capacity, thus making it possible to improve the metal recovery yield.

Preferably, the heteroatom is chosen from oxygen, sulfur and nitrogen.

Preferably, the heteroatom is chosen from oxygen and nitrogen.

Particularly preferably, the heteroatom is oxygen.

Preferably, the agent according to the invention is 1,5-dimercapto-3-oxapentane (HS—CH₂—CH₂—O—CH₂—CH₂—SH), that is to say that the groups R and R′ each represent a hydrogen atom, A corresponds to formula (II), n is equal to 1, m is equal to 1 and the groups Y₁ and Y₂ each represent a hydrogen atom.

Preferably, the agent according to the invention is 1,8-dimercapto-3,6-dioxaoctane (DMDO, sold by the company Arkema), that is to say that the groups R and R′ each represent a hydrogen atom, A corresponds to formula (II), n is equal to 2, m is equal to 2 and the groups Y₁ and Y₂ each represent a hydrogen atom.

According to another preferred embodiment, the agent according to the invention is 1,11-dimercapto-3,6,9-trioxaundecane, that is to say that the groups R and R′ each represent a hydrogen atom, A corresponds to formula (II), n is equal to 3, m is equal to 3 and the groups Y₁ and Y₂ each represent a hydrogen atom.

Particularly preferably, the heteroatom is sulfur.

According to yet another preferred embodiment, the agent according to the invention is 1,5-dimercapto-3-thiapentane (HS—CH₂—CH₂—S—CH₂—CH₂—SH or diethyl sulfid dimercaptan), that is to say that the groups R and R′ each represent a hydrogen atom, A corresponds to formula (II), n is equal to 1, m is equal to 1 and the groups Y₁ and Y₂ each represent a hydrogen atom.

According to yet another preferred embodiment, the agent according to the invention is 1,8-dimercapto-3,6-dithiaoctane, that is to say that the groups R and R′ each represent a hydrogen atom, A corresponds to formula (II), n is equal to 2, m is equal to 2 and the groups Y₁ and Y₂ each represent a hydrogen atom.

According to yet another preferred embodiment, the agent according to the invention is 1,11-dimercapto-3,6,9-trithiaundecane, that is to say that the groups R and R′ each represent a hydrogen atom, A corresponds to formula (II), n is equal to 3, m is equal to 3 and the groups Y₁ and Y₂ each represent a hydrogen atom.

Particularly preferably, the heteroatom is nitrogen.

In this configuration, and according to one embodiment of the invention, the agent according to the invention is 1,5-dimercapto-3-azapentane HS—CH₂—CH₂—NH—CH₂—CH₂—SH, that is to say that the groups R and R′ each represent a hydrogen atom, A corresponds to formula (II), n is equal to 1, m is equal to 1 and the groups Y₁ and Y₂ each represent a hydrogen atom.

According to another preferred embodiment, the agent according to the invention is 1,8-dimercapto-3,6-diazaoctane, that is to say that the groups R and R′ each represent a hydrogen atom, A corresponds to forming (II), n is equal to 2, m is equal to 2 and the groups Y₁ and Y₂ each represent a hydrogen atom.

According to yet another preferred embodiment, the agent according to the invention is 1,11-dimercapto-3,6,9-triazaundecane, that is to say that the groups R and R′ each represent a hydrogen atom, A corresponds to formula (II), n is equal to 3, m is equal to 3 and the groups Y₁ is and Y₂ each represent a hydrogen atom.

Another subject of the invention is a composition comprising at least one flotation agent according to the invention.

Preferably, said composition also comprises:
at least one additional flotation agent chosen from xanthates, alkyl mercaptans, organic sulfides, thiophosphates, thiocarbonates, thioureas, thiocarbamides, dialkyl thionocarbamates, dialkyldithiocarbamates, phosphinates, dialkyl esters of xanthogen, such as, for example, dialkylformates of xanthogen, dialkyl dithiophosphates, dialkyl monothiophosphates, and the like, and also the mixtures of two or more in any proportions;
azo and diazo compounds and mixtures thereof;
at least one activating agent and/or at least one conditioning agent chosen from copper salts, such as copper sulfates, lead salts, zinc salts, metal sulfides, pH regulators, such as caustic soda, sodium carbonate, cyanides and mixtures thereof;
at least one foaming agent chosen from alcohols, such as, for example, methyl isobutyl carbinol (MIBC sold by the company Arkema), pine oils, fatty oils, glycols such as ethylene glycol and propylene glycol, cresylic acid and mixtures thereof, optionally as a mixture with sulfonates, for example cumene sulfonates;
optionally one or more depressants;
water;
optionally one or more solvents.

Preferably, said composition comprises at least one flotation agent according to the invention and at least one additional flotation agent well known to those skilled in the art, the ratio of the mixtures of flotation agents possibly varying within very wide proportions, in particular according to the nature of the flotation agents, the flotation conditions and the elements to be floated. The composition of the novel flotation agent contains from 0.1% by weight to 100% by weight of the molecule of formula (I) mentioned above, A corresponding to a formula chosen from formulae (II), (III) and (IV), preferably from formulae (II) and (IV), and more preferably A corresponds to formula (II), which are mentioned above, preferably from 5% to 75% of the molecule of formula (I) mentioned above, A corresponding to a formula chosen from formulae (II), (III) and (IV), preferably from formulae (II) and (IV), and more preferably A corresponds to formula (II), wish are mentioned above, the remainder to 100% by weight consisting of at least one component of the formulation mentioned above.

Particularly preferably, said composition consists of at least one flotation agent according to the invention, and optionally at least one solvent.

When the flotation agent is used with one or more others from the components listed above, the various components forming the flotation composition can be added simultaneously, consecutively, and/or sequentially.

Another subject of the invention is the use of at least one flotation agent according to the invention, for the flotation of ores.

Another subject of the invention is the use of at least one composition as described above, for the flotation of ores.

Another subject of the invention is a process for flotation recovery of metal compounds contained in ores, comprising a step of introducing at least one flotation agent according to the invention into a flotation cell containing water and a mixture of ores to be separated.

Advantageously, during said flotation recovery process, the flotation agent according to the invention is added to the flotation cell according to a weight ranging from 1 to 1000 grams, preferably from 5 to 200 grams, preferably from 10 to 100 grams, more preferably from 20 to 50 grams, per tonne of ore.

The flotation agent according to the invention can be suitable for the recovery of metal compounds, such as oxides and/or sulfides, comprising one or more metals chosen from the group containing, in a nonlimiting manner: gold, silver, lead, zinc, copper, molybdenum, nickel, cobalt, palladium, osmium, ruthenium, rhodium, iridium and platinum.

1. A flotation agent of formula (I): 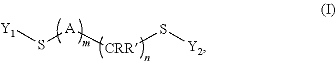
wherein A is a formula selected from: 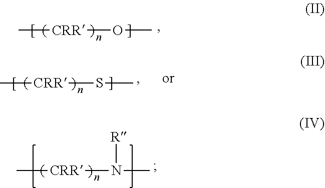
wherein:
the group R is selected from a hydrogen atom or a C₁-C₄ alkyl radical;
the group R′, which may be identical to or different from the group R, is selected from a hydrogen atom, or a C₁-C₄ alkyl radical;
the group R″, which may be identical to or different from the groups R and R′, is selected from a hydrogen atom or a C₁-C₄ alkyl radical;
n is an integer between 1 and 6, limits inclusive;
m is an integer between 1 and 20, limits inclusive;
the groups Y₁ and Y₂, independently of one another, are selected from X₁ or a radical C(S)SX₂; wherein X₁ is selected from a hydrogen atom or an alkali metal or an alkaline-earth metal, and X₂ is selected from an alkali metal or an alkaline-earth metal or hydrogen.

2. The flotation agent according to claim 1, wherein n is an integer between 1 to and 4, limits inclusive.

3. The flotation agent according to claim 1, wherein m is an integer between 2 and 5, limits inclusive.

4. The flotation agent according to claim 1, wherein R, R′ and R″, which may be identical or different, are each independently selected from a hydrogen atom, a methyl group, an ethyl group, a propyl group, a butyl group, or isomers thereof.

5. The flotation agent according to claim 1, wherein A is selected from formula (II) or formula (IV).

6. The flotation agent according to claim 1, wherein X₁ is selected from a hydrogen atom or an alkali metal.

7. The flotation agent according to claim 6, wherein X₁ is a hydrogen atom.

8. The flotation agent according to claim 1, wherein X₂ is an alkali metal.

9. The flotation agent according to claim 1, wherein the groups Y₁ and Y₂ are hydrogen atoms.

10. The flotation agent according to claim 1, wherein the flotation agent is 1,8-dimercapto-3,6-dioxaoctane.

11. A composition comprising at least one flotation agent according to claim 1.

12. (canceled)

13. (canceled)

14. A method for flotation recovery of metal compounds contained in ores, comprising a step of introducing at least one flotation agent according to claim 1 into a flotation cell containing water and a mixture of ores to be separated.

15. A method for flotation recovery of metal compounds contained in ores, comprising a step of introducing at least one composition according to claim 11 into a flotation cell containing water and a mixture of ores to be separated.

16. The flotation agent according to claim 1, wherein n is an integer between 1 and 3, limits inclusive.

17. The flotation agent according to claim 1, wherein A corresponds to formula (II).

18. The flotation agent according to claim 1, wherein X₁ is selected from a hydrogen atom, sodium or potassium.

19. The flotation agent according to claim 1, wherein X₂ is sodium or potassium.

20. The flotation agent according to claim 1, wherein the group R is selected from a hydrogen atom or a C₁-C₂ alkyl radical.

21. The flotation agent according to claim 1, wherein the group R′ is selected from a hydrogen atom or a C₁-C₂ alkyl radical.

22. The flotation agent according to claim 1, wherein the group R″ is selected from a hydrogen atom or a C₁-C₂ alkyl radical.
